(19) United States
(12) Patent Application Publication
(10) Pub. No.: US 2013/0232914 A1
(43) Pub. Date: Sep. 12, 2013

(54) WRAPPING MODULE FOR A BUNDLING INSTALLATION

(71) Applicants: Michael Vasse, Octeville-Sur-Mer (FR); Lionel Daniere, Octeville-Sur-Mer (FR); Gregory Choplin, Octeville-Sur-Mer (FR)

(72) Inventors: Michael Vasse, Octeville-Sur-Mer (FR); Lionel Daniere, Octeville-Sur-Mer (FR); Gregory Choplin, Octeville-Sur-Mer (FR)

(73) Assignee: SIDEL PARTICIPATIONS, Octeville-Sur-Mer (FR)

(21) Appl. No.: 13/885,102

(22) PCT Filed: Nov. 4, 2011
(86) PCT No.: PCT/FR11/52576

§ 371 Date: May 13, 2013

(30) Foreign Application Priority Data
Nov. 19, 2010 (FR) 10 59524

(51) Int. Cl. B65B 59/00; B65B 45/00; B65G 15/60

(52) U.S. Cl. CPC B65B 59/00; B65G 15/60; B65B 45/00
USPC 53/203; 198/837

(57) ABSTRACT

The invention comprises, combined in a U-shaped cradle (5), a wrapping table (11) and a cycler (12), the bars (13) of which are mounted on endless chains (14) in order to revolve all around said table (11). The structure (21) of the table consists of side members (23) which are extended by extensions (22) in the form of retractable arms (32), the ends of which carry rollers (33) for guiding the belt (25) and said structure (21) is secured, by way of appropriate, easily removable means, to at least one of the side walls of the cradle (5) which is in the form of a frame (8) perforated by a window (28). The window (28) has a dimension in the longitudinal direction which is less than the overall length of said table (11), but this dimension is greater than the length of said table (11) following retraction of its end arms (32) so that the belt (25) can be removed and a new belt can be fitted.

The invention relates to an improvement to installations for packaging products in plastic film, commonly called bundlers, and more particularly to an improvement to the wrapping station where a plastic film is wrapped around successive batches of products.

This type of installation, as described in particular in document EP 0 403 079, extends between a machine for preparing products, such as bottles for example, and a tunnel for heat-shrinking the plastic film surrounding each batch of products.

This machine comprises arrangements which allow grouping batches before the actual bundling operation is performed, and these batches are then sequentially introduced, at a given pace, into the station which is referred to as the wrapping station. This wrapping station receives the batch of products, and at the same time receives a sheet of the heat shrinkable plastic material. It is at this wrapping station that the batch is wrapped with said plastic sheet.

The wrapping station comprises a wrapping table, which receives the batch of products, and a cycler with wrap bars which takes the plastic film and wraps it around the batch as the batch advances on said wrapping table.

The wrapping table therefore acts as a conveyor; it comprises an endless belt, which advances at a speed which is synchronized with the speed of the bars of the cycler in order to perform this operation of wrapping the batch with plastic film.

This indispensable synchronization between the conveyor belt and the cycler imposes certain constraints on the belt concerning its advancement, which must occur in a very precise manner. To obtain this result, the belt is subjected to relatively high stresses. These stresses have the effect of including this belt among the wear parts which must be replaced, and in particular among the parts which are preferably changed systematically without waiting for them to wear out, as that could have serious consequences during the normal operation of the installation.

However, it is difficult to access this belt when it is installed in a wrapping table; it is enveloped by the cycler which means any interventions will be time-consuming and involve multiple operators, which of course impacts the use of the machine.

The invention proposes a novel arrangement of this wrapping station, with an original arrangement of the wrapping table itself, such that this operation of changing the belt can be done under acceptable conditions, within a relatively short time, and without requiring the involvement of multiple operators.

The wrapping module of the invention comprises, combined in a cradle having a transverse cross-section in the shape of a U,—a wrapping table of which the ends of its structure each comprise one or more rollers for guiding an endless belt, and—a cycler having bars mounted on endless chains in order to revolve all around said wrapping table, characterized in that the structure of said wrapping table consists of laterally arranged side members which are extended by extensions in the form of retractable arms whose ends carry said rollers, and said structure is secured, by easily removable means, to at least one of the side walls of said cradle, said wall being in the form of a frame pierced with a window opening onto said wrapping table, said window having a dimension, in the longitudinal direction, which is less than the total length of the table but which is greater than the length of said table after retraction of its end arms, which will allow the removal of said endless belt and/or the insertion of another belt.

Still according to the invention, the active upper portion of the conveyor belt slides on a bed made of several parts, said bed comprising:—a fixed central plate carried by the side members, and—supplemental plates carried by the retractable arms which support the end rollers serving to guide said belt.

In another arrangement of the invention, the retractable arms which support the end rollers serving to guide the belt, can be vertically moved to allow retraction of their supplemental guide plate for the belt, and to allow positioning these supplemental plates under the fixed central plate.

Still according to the invention, the side members of the structure of the wrapping table comprise longitudinal slots which act as rails and which guide the attachment means for the retractable end arms during their retraction movement which allows positioning their supplemental plate under the fixed central plate.

In another arrangement of the invention, the structure of the wrapping table is secured to the windowed frame by means of brackets, in the form of angle brackets, which are removable and which, after their removal, leave said table in a cantilevered arrangement, supported by attachment means which are placed between its structure and the other wall of the cradle.

In another arrangement of the invention, the lower portion of the endless belt is wound around a motorized roller by means of two supplemental rollers arranged above and on each side of said motorized roller in order to wind said belt around half the surface area of said motorized roller, said supplemental rollers being secured to the structure of the table by quick-disconnect assembly means, of the simple screw type, which directly engage with a respective shaft onto which each supplemental roller is mounted.

In another arrangement of the invention, the side plates carried by the end arms abut against the fixed central plate, and, on one side, at least one fine-tuning adjustment device is placed between said arms and the side members of the structure, said adjustment device allowing moving the corresponding supplemental plate forward or back to adjust its gap relative to the bars of the cycler and/or relative to the bed or to a next adjacent belt.

The invention also relates to the conveying table itself, used in a bundling installation for the wrapping operation. From GB 2 041 315 and EP 1 493 692, conveying tables are known which can be used in a bundling installation for the wrapping operation, and each comprising a structure which is equipped, on at least one of its longitudinal ends, with supporting arms for one or more guide rollers for an endless conveyor belt, said supporting arms being movable, longitudinally retractable, in a manner that reduces the longitudinal dimensions of said table by appreciable proportions, said belt comprising an active upper portion which slides on a bed made of several parts, one part comprising a fixed central plate carried by side members and one part comprising at least one supplemental guide plate which is carried by said retractable arms that support said end roller(s) serving to guide the belt, which allows adjusting the tension of the belt and/or facilitates removal and replacement of the belt.

The conveying table of the invention, of the known type presented above, is characterized by said retractable arms being vertically movable to allow retraction of their supplemental guide plate for said belt and to allow positioning their supplemental guide plate under the fixed central plate.

Advantageously, the side members of the table structure comprise longitudinal slots which act as rails and which guide the attachment means for the retractable arms during their retraction movement which allows positioning their supplemental guide plate under the fixed central plate.

The longitudinal dimensions of the conveying table can thus be reduced by an amount on the order of 10 to 25% for example.

The invention is explained in a sufficiently clear and complete manner in the following description to enable its execution. This description is accompanied by drawings, in which:

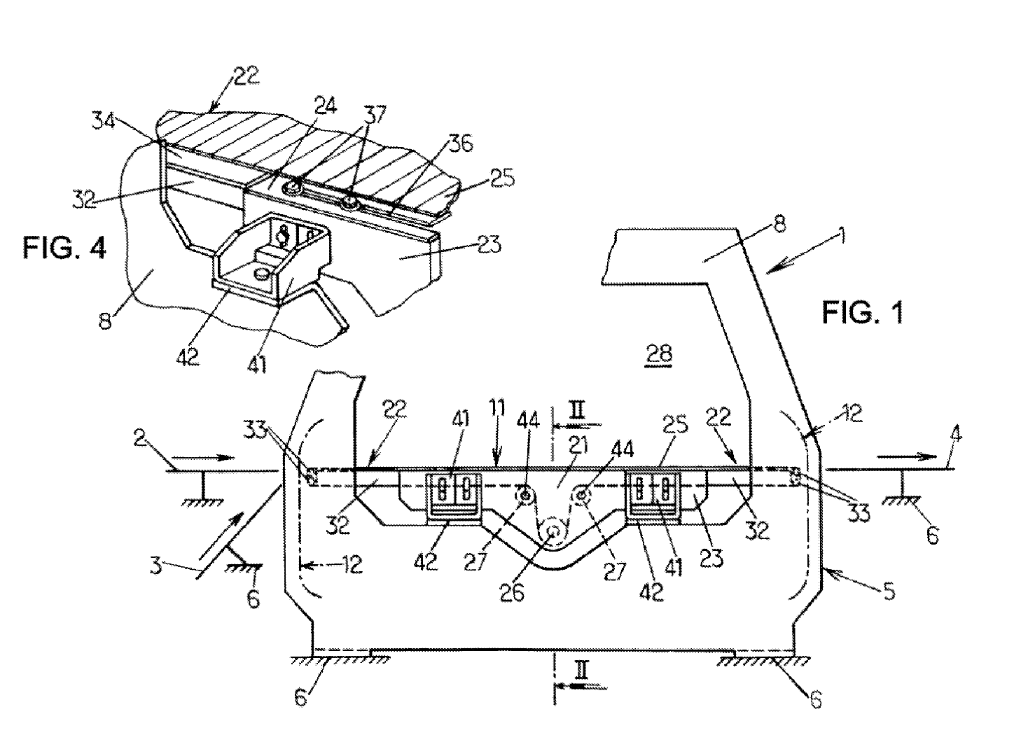

FIG. 1 schematically represents the wrapping module of the invention, viewed from the side where the endless conveyor belt is removed;

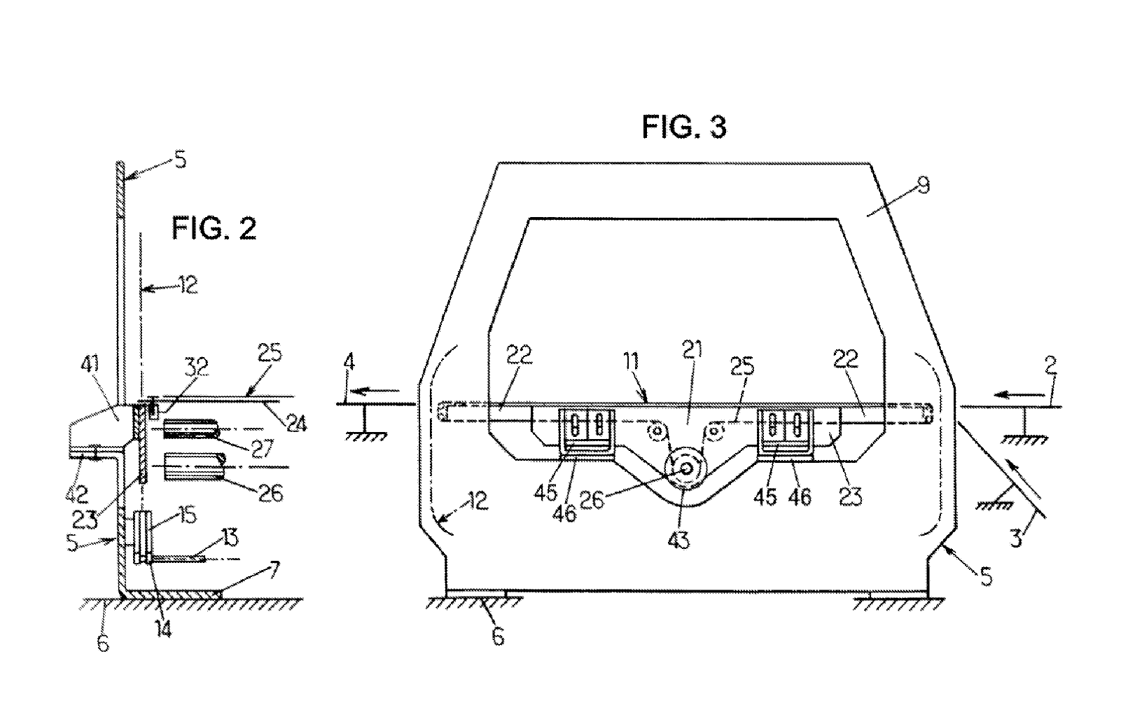

FIG. 2 is a schematic half-view of a cross-section along II-II in FIG. 1, primarily showing the cradle which groups the active elements of this wrapping module;

FIG. 3 represents the module, viewed from the side opposite the side in FIG. 1, specifically from the side where the drive means for the wrapping module belt are located;

FIG. 4 shows a detailed schematic perspective view of a quick-connect element for attaching the structure of the wrapping table to the windowed frame of the cradle;

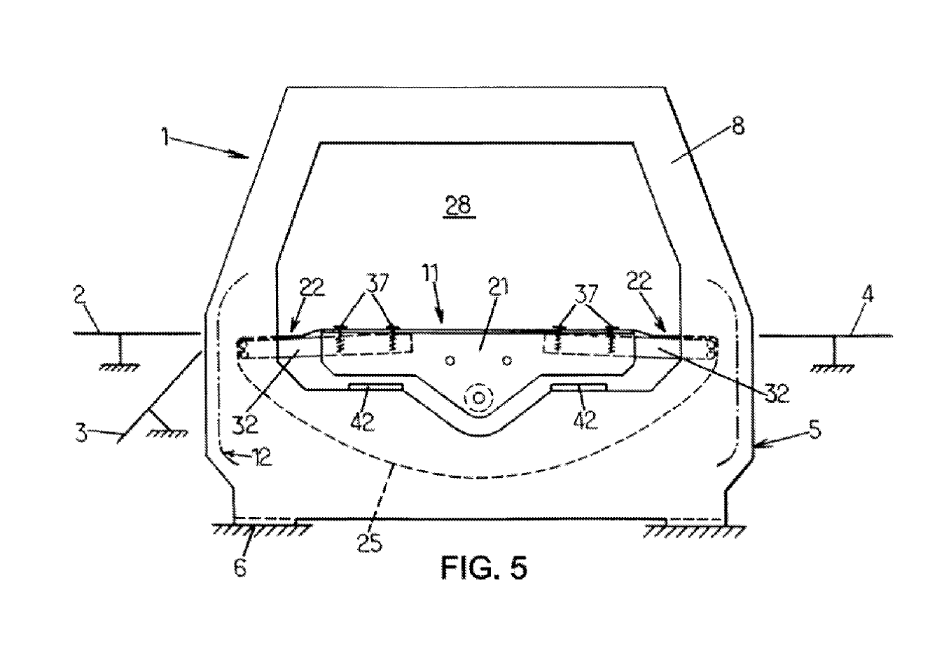

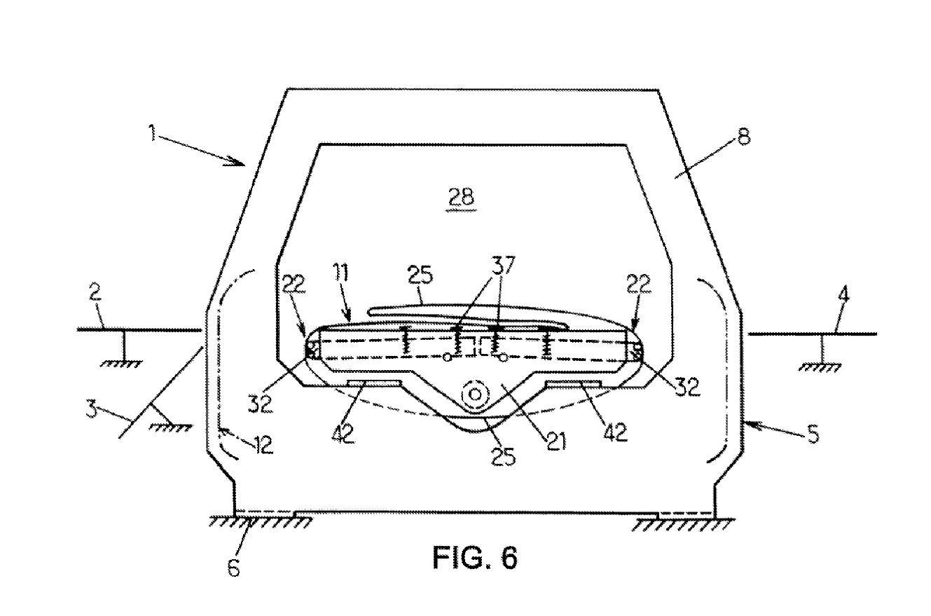

FIGS. 5 and 6 show the different operations involved in the extraction and/or replacement of the endless belt of the wrapping module.

FIG. 1 shows the wrapping module 1, which is placed between an upstream conveyor 2 supplying the batches of products, under which one will note the plastic film injection table 3, and a downstream conveyor 4 which conveys the batch of products, wrapped in its plastic film, to the heat-shrink tunnel, not represented.

This wrapping module 1 comprises a cradle 5 which is partially apparent in the transverse half-section represented in FIG. 2. This cradle 5 rests on the general frame 6 of the bundling installation and is in the shape of a U of which the bottom 7 rests on said general frame with two side walls which form frames, it being possible for said frames to be similar or different as explained below; they are labeled differently: one, frame 8, is directly visible in FIG. 1; the other, frame 9, is directly visible in FIG. 3.

The cradle 5 is arranged to receive, between its two frames 8 and 9, the wrapping table 11 and the cycler 12 which is diagrammed in FIGS. 1 and 3. This cycler 12 is simply represented by dotted and dashed lines illustrating a portion of the path of the bars of this cycler 12, said bars 13 appearing in FIG. 2.

Still in FIG. 2, the cycler 12 comprises endless chains 14, which carry the bars 13, said chains 14 being laterally arranged and their path being defined in particular by guides 15 located on the inside face of the frames 8 and 9. The bars 13 surround the wrapping table 11 in their movement. To allow the bars 13 to pass between the ends of this wrapping table 11 and the ends of the upstream conveyor 2 feeding the batches of products and the downstream entrance to the conveyor 4, an appropriate gap is left between each end of said table 11 and, respectively, the downstream end of said feed conveyor 2 and the upstream end of the conveyor 4 located downstream.

The total length of the wrapping table 11 is determined by the distance between the upstream passage for the bars 13 of the cycler 12, at the entrance to the wrapping module 1, and the downstream passage for these same bars, at the exit from said wrapping module 1, said distance being measured at the surface where the batches of products travel.

The wrapping table 11 comprises a structure 21 constituting its central portion, and two side extensions 22 which extend out to the path of the bars 13.

The structure 21 laterally comprises side members 23, said side members being joined by a plate 24, visible in FIGS. 2 and 4, said plate 24 acting as a bed for the endless conveyor belt 25 which extends between the entrance and the exit of the wrapping module 1.

These side members 23 also comprise means for receiving the motorized roller 26 which drives the belt 25 and for receiving the two supplemental rollers 27, said rollers 27 being located above the level of the axis of the motorized roller 26 and on each side of the motorized roller 26; they allow winding the belt 25 around slightly more than half of the motorized roller 26.

One will note in FIG. 1 that the structure 21, with its side members 23, is inside the window 28 arranged in the side wall of the cradle 5 which forms the frame 8. It is the extensions 22, on each side of the central portion of the structure 21, which give the wrapping table 11 a longitudinal dimension which is greater than the longitudinal dimension of the window 28.

These extensions 22 each consist of laterally arranged arms 32, said arms 32 constituting a kind of extension of the side members 23 and carrying, at their end, the roller(s) 33 which serve to guide the winding of the wrapping module belt 25.

The arms 32 are connected to each other by a plate 34 which also acts as a bed for the belt 25. This plate 34, visible in FIG. 4, abuts with the central fixed plate 24 in order to create continuity in the guiding of the wrapping belt 25.

The fixed central plate 24 laterally comprises, at the side members 23, longitudinal slots 36 which act to guide the attachment means for the arms 32, said attachment means consisting for example, as represented in FIG. 4, of a pair of screws 37 which engage with the end of each arm 32 which is positioned under the plate 24 and against the corresponding side member 23.

Considering the presence of the plate 34 which is carried by the arms 32, in order to be able to retract the extensions 22 it is necessary to move this extension 22 vertically downwards in order to allow said plate 34 to pass under the central plate 24, as represented in FIGS. 5 and 6.

The wrapping table 11 is supported by and assembled onto the cradle 1 by means of its structure 21, and in particular by the side members 23 of this structure 21. The side members 23 are supported, on the frame 8 and window 28 side, by parts 41 in the form of angle brackets which rest on a supporting shelf 42 arranged in said frame 8, in the lower portion of the window 28.

The lower portion of the window 28 is arranged, as represented in FIG. 1, to have a contour which corresponds to that of the side members 23 of the structure 21 but with a significant gap between the two.

FIG. 1 shows the window 28 of frame 8, meaning the side from which an operator can access the belt 25 and remove it for replacement when necessary.

FIG. 3 shows the other side of the cradle 1 with frame 9, said frame 9 possibly being, for reasons of simplicity, arranged similarly to frame 8 with the same type of window. One will note a wheel 43 in FIG. 3 which is secured to the motorized roller 26, said wheel 43 being driven by the same drive means as the chains 14 on which the bars 13 are mounted, so that the two are driven in a synchronized manner and the operation of wrapping the batch of products with plastic film is carried out.

The presence of the drive system for the belt 25 on the frame 9 side complicates the belt changing operations, and it is for this reason that these operations are performed from the other side, where an operator can work easily without needing to execute multiple operations in order to free the belt 25 which, of course, can be cut apart when changing a worn belt but when new forms an envelope which it must be possible to thread onto the wrapping table 11 without ruining it.

For this belt 25 changing operation, a first operation is performed, as represented in FIG. 5, which consists of removing the attachment means for the supplemental rollers 27 that guide the belt 25 on its motorized roller 26, said attachment means consisting, for example, of screws 44 which secure two shafts which each have a respective one of said rollers 27 mounted to it. Next, the operation consists of loosening the screws 37 which attach the arms 32 to the fixed central plate 24, to free the extensions 22 to move downwards in order to retract each of the plates 34 and to place them under said fixed central plate 24.

The changing operation then consists of removing the angle brackets 41 which support the table 11, said table then being supported in a cantilevered manner by the angle brackets 45 located on the other side, on the frame 9 of the cradle 5, said angle brackets 45 being attached to the side members 23 of the structure 21 and to the supporting shelves 46 which are arranged on said frame 9, in the lower portion of the corresponding window.

To be able to remove the belt 25, the operator retracts the extensions 22 by sliding them under the fixed central plate 24, as represented in FIG. 6. The removal of the angle brackets 41 leaves the passage area for the belt 25 unobstructed, so that said belt 25 can be extracted by the operator from the front simply by sliding the belt transversely on the table 11, above the supporting shelves 42 and, in general, above the lower contours of the window 28.

After having installed a new belt 25, the operator performs the reverse operation by restoring the angle brackets 41, the supplemental rollers 27, and, lastly, the side extensions 22, with the plates 34 abutting against the central plate 24.

One will note that supplemental means may be installed for making positional adjustments, for example such as an adjustment between plates 24 and 34. A fine-tuning adjustment system, not represented, may be installed which allows adjusting the position of the end of the extensions 22 relative to the passage traveled by the bars 13, said adjustment also making it possible to improve the position of the ends of the belt 25 relative to the bed or to the adjacent belt located downstream or upstream from the wrapping module 1.

1-9. (canceled)

10. A wrapping module comprising, combined in a cradle having a transverse cross-section in the shape of a U,—a wrapping table of which two ends of a structure of said wrapping table each comprise one or more rollers for guiding an endless belt, and—a cycler having bars mounted on endless chains in order to revolve all around said wrapping table, wherein said structure of said wrapping table comprising laterally arranged side members which are extended by extensions in the form of retractable arms whose ends carry said rollers, and said structure is secured, by easily removable means, to at least one of side walls of said cradle, said at least one of said side walls being in the form of a frame pierced with a window opening onto said wrapping table, said window having a dimension, in the longitudinal direction, which is less than the total length of said table but which is greater than the length of said table after retraction of said end arms.

11. The wrapping module according to claim 10, wherein an active upper portion of said conveyor belt slides on a bed made of several parts, said bed comprising:—a fixed central plate carried by said side members, and—supplemental plates carried by said retractable arms which support said end rollers serving to guide said belt.

12. The wrapping module according to claim 11, wherein said retractable arms which support said end rollers serving to guide said belt, can be vertically moved to allow retraction of said supplemental guide plate for said belt, and to allow positioning said supplemental guide plates under said fixed central plate.

13. The wrapping module according to claim 12, wherein said side members of said structure of said wrapping table comprise longitudinal slots which act as rails and which guide attachment means for said retractable arms during retraction movement of said retractable arms which allows positioning said supplemental plate under said fixed central plate.

14. The wrapping module according to claim 10, wherein said structure of said wrapping table is secured to said frame by means of brackets, in the form of angle brackets, which are removable and which, after their removal, leave said wrapping table in a cantilevered arrangement, supported by attachment means which are placed between said structure and the other side wall of said cradle.

15. The wrapping module according to claim 10, wherein a lower portion of said endless belt is wound around a motorized roller by means of two supplemental rollers arranged above and on each side of said motorized roller in order to wind said belt around half the surface area of said motorized roller, said supplemental rollers being secured to said structure of said wrapping table (11) by quick-disconnect assembly means of the simple screw type, which directly engage with a respective shaft onto which each said supplemental roller is mounted.

16. The wrapping module according to claim 11 wherein said supplemental plates carried by said end arms abut against said fixed central plate, and, on one side, at least one fine-tuning adjustment device is placed between said end arms and said side members of said structure, said adjustment device allowing moving a corresponding supplemental plate forward and back to adjust a gap relative to at least one of said bars of said cycler and said bed or an adjacent belt.

17. A conveying table used in a bundling installation for a wrapping operation, the conveying table comprising a structure which is equipped, on at least one of two longitudinal ends of said conveying table, with supporting arms for one or more guide rollers for an endless conveyor belt, said supporting arms being movable, longitudinally retractable, said belt comprising an active upper portion which slides on a bed made of several parts, one part comprising a fixed central plate carried by side members, and—one other part comprising at least one supplemental guide plate which is carried by said supporting arms that support said end roller(s) serving to guide said belt, wherein said supporting arms are vertically movable to allow retraction of their supplemental guide plate for said belt and to allow positioning said supplemental guide plate under said fixed central plate.

18. The conveying table according to claim 17, wherein said side members of said structure of said conveying table comprise longitudinal slots which act as rails and which guide attachment means for said supporting arms during a retraction movement thereof which allows positioning said supplemental guide plate under said fixed central plate.
